(19) United States
(12) Patent Application Publication
(10) Pub. No.: US 2019/0025599 A1
(43) Pub. Date: Jan. 24, 2019

(54) BEAM SHAPER WITH OPTICAL FREEFORM SURFACES AND LASER OPTIC WITH A BEAM SHAPER OF THIS KIND

(71) Applicant: asphericon GmbH, Jena (DE)

(72) Inventors: Ulrike FUCHS, Jena (DE); Sven WICKENHAGEN, Jena (DE); Sven KIONTKE, Jena (DE)

(73) Assignee: asphericon GmbH, Jena (DE)

(21) Appl. No.: 16/040,960

(22) Filed: Jul. 20, 2018

(30) Foreign Application Priority Data
Jul. 21, 2017 (DE) DE102017116476.6

(51) Int. Cl. G02B 27/09; G02B 27/30

(52) U.S. Cl. CPC G02B 27/0927; G02B 1/11; G02B 27/30

(57) ABSTRACT

A beam shaper is provided that includes two optical elements arranged one behind the other along an optical axis. Each optical element has at least one optically active freeform surface. The optical elements are arranged displaceable by a relative displacement against each other along at least one axis substantially perpendicular to the optical axis. The optically active freeform surfaces have a height profile, which is a polynomial expansion having polynomial coefficients different from zero in finitely many polynomial orders. At least one polynomial coefficient, assigned to a polynomial order greater than three, is different from zero. The height profiles of the at least two freeform surfaces are selected such that input beams distributed rotationally symmetric about the optical axis with a Gaussian beam density profile are diffracted into output beams which are limited in a receiving plane within a rectangular cross section and are uniformly distributed about the optical axis.

This nonprovisional application claims priority under 35 U.S.C. § 119(a) to German Patent Application No. DE 10 2017 116 476.6, which was filed in Germany on Jul. 21 2017, and which is herein incorporated by reference.

### BACKGROUND OF THE INVENTION

### Field of the Invention

The present invention relates to a beam shaper having optical freeform surfaces, which can be moved perpendicular to the optical axis, in order to produce a rectangular beam density profile. A rectangular beam density profile has a homogeneous beam density within a rectangular cross section around and perpendicular to an optical axis. Outside the rectangular cross section, a rectangular beam density profile has no or a negligibly low beam density.

### Description of the Background Art

Beam shapers are known from the prior art, with which bundles of collimated input beams, whose distribution in an entrance plane perpendicular to the optical axis is determined by an input beam density distribution, are transformed into bundles of collimated output beams whose distribution in an exit plane perpendicular to the optical axis is determined by an output beam density distribution. For example, beam shapers are known in which the input beam density distribution is determined by a rotationally symmetric Gaussian profile and the output beam density distribution by a top-hat profile.

Further, focusing vario-optical systems are known from the prior art whose focal length can be changed along the optical axis pointing in a direction z by moving two optical elements with partial surfaces in a direction x perpendicular to the optical axis, wherein the partial surfaces are formed as freeform surfaces. It is known that two equally shaped partial surfaces, extending along directions x, y perpendicular to each other and to the optical z-axis and spaced apart by a distance e in the direction of the optical z-axis,

$${z}^{( 1 )} ( x , y ) = A ( \frac{{x}^{3}}{3} + {xy}^{2} )$$

$${z}^{( 2 )} ( x , y ) = A ( \frac{{x}^{3}}{3} + {xy}^{2} ) + ɛ$$

cause a change in the focal length.

The focal length in the case of a displacement by Δx along the x-axis is:

$$f = \frac{1}{4 A Δ x ( n - 1 )}$$

wherein n is the refractive index of the material that is the same for both optical elements and the free beam passage between the optical elements occurs in air.

### SUMMARY OF THE INVENTION

It is therefore an object of the present invention to provide a beam shaper with which collimated input beams with an input beam density distribution corresponding to a rotationally symmetric Gaussian profile are transformed into output beams whose output beam density follows a rectangular beam density profile in a receiving plane, a profile which is variable at least along one dimension. The invention is based in particular on the object of providing a beam shaper of this kind, which enables a particularly short overall length. The invention is further based on the object of providing a laser optic for laser material processing with an improved processing quality, which is particularly easy to adjust for different beam densities and/or for different working distances.

In an exemplary embodiment, a beam shaper is provided that has at least one first optical element and a second optical element arranged along an optical axis after the first optical element. The first and second optical elements are displaceable against each other along at least one displacement axis, which is arranged perpendicular to the optical axis.

The first and second optical elements each have at least one optically active freeform surface. Each freeform surface can be described by a height profile, which assigns a height difference to each point of the freeform surface as a distance in the direction of the optical axis relative to a reference point of the freeform surface. Preferably, a reference point is selected so that it lies centrally in a freeform surface.

For each displacement of the first optical element relative to the second optical element, the optical effect of the beam shaper results from the entirety of the change, effected for each incoming input beam, in the beam path. For optical elements with given freeform surfaces, the optical effect of a beam shaper can be determined by means of beam calculation with any accuracy in principle within the limits of the geometric optics. Methods for beam calculation for optical elements with freeform surfaces are known from the prior art.

The height profile of a freeform surface can be described by a polynomial expansion which has polynomial coefficients that are different from zero in finitely many polynomial orders, wherein at least one polynomial coefficient assigned to a polynomial order greater than three is different from zero.

The polynomial coefficients of such a polynomial expansion are selected for each freeform surface of the optical elements such that the beam density distribution follows a rectangular beam density profile in a receiving plane arranged on the exit side of the beam shaper at a focus distance, wherein the focus distance and the extent of the rectangular beam shaper profile are variable depending on the displacement of the first relative to the second optical element.

In an embodiment of the invention, in each case a freeform surface of the first and second optical element is arranged facing one another along the optical axis, wherein the height profile of these freeform surfaces is formed antisymmetric with respect to a 180 degree rotation about the optical axis.

This offers the advantage that the first and second optical element are made similar and are to be mounted in the beam shaper only rotated by 180 degrees about the optical axis relative to each other. This reduces the cost of producing the beam shaper.

The optical elements can be made of silica glass. Silica glass is particularly resistant to temperature changes and has a low thermal expansion coefficient. This embodiment is therefore particularly suitable for the beam shaping of laser beams at high laser powers. In a preferred variant of this embodiment, in addition, optically active surfaces of the optical elements are provided with an anti-reflective coating in order to reduce optical losses and their conversion into heat.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows two optical elements with freeform surfaces in the zero position;

FIG. 2 schematically shows a surface profile of a freeform surface;

FIG. 3 schematically shows two optical elements, displaced to each other, with freeform surfaces;

FIGS. 4A and 4B schematically show beam paths for a beam shaper with two freeform surfaces for different displacement positions;

FIG. 5 schematically shows the assignment of entry points in an entrance plane to receiving points in a receiving plane for beams through a beam shaper; and

FIG. 6 schematically shows a laser optic with a beam shaper.

### DETAILED DESCRIPTION

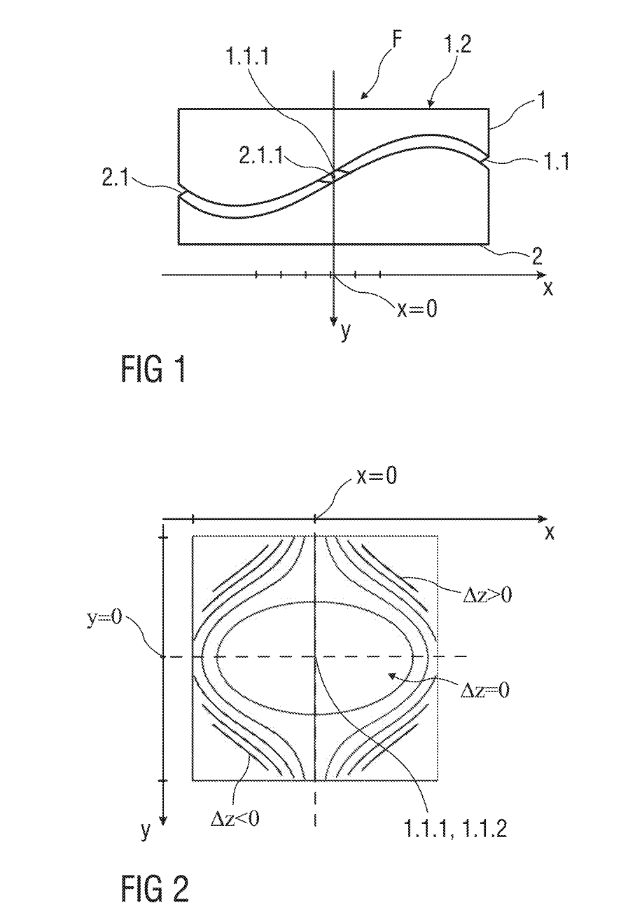

FIG. 1 shows a beam shaper F having a first optical element 1 and a second optical element 2 made of an optically dense material having a refractive index n>1. Optical elements 1, 2 have freeform surfaces 1.1, 2.1, which are arranged opposite one another along an optical z-axis. Optical elements 1, 2 are displaceable to each other along a first horizontal x-axis, perpendicular to the optical z-axis, and are arranged immovable to each other along a second y-axis, perpendicular to both the optical z-axis and the first x-axis. However, exemplary embodiments of the invention are also possible in which optical elements 1, 2 are displaceable in addition along the second y-axis.

Mechanical devices for the arrangement of optical elements displaceable perpendicular to the optical z-axis are known from the prior art. For example, optical elements 1, 2 can be mounted in mounts, which are displaceable against each other via a spindle screw in the x-direction. Solutions are known with which optical elements 1, 2 are displaceable in the x-direction to each other and to the optical z-axis. It is also possible, however, that a first optical element 1 is arranged immovably to the optical z-axis and the other optical element 2 is displaceable with respect to the optical z-axis, and thus also with respect to first optical element 1 in the x-direction.

Each optical element 1, 2 has its freeform surface 1.1, 2.1 opposite a planar surface 1.2, 2.2, which is perpendicular to the optical z-axis. Embodiments of the invention are also possible, however, in which the surface opposite freeform surface 1.1, 1.2 is not made planar. Further, embodiments are possible in which planar surfaces 1.2, 2.2 of the optical elements are arranged opposite one another and freeform surfaces 1.1, 2.1 are arranged pointing away from one another.

Freeform surfaces 1.1, 2.1 are made complementary and in a zero position arranged one after the other, spaced apart by an offset ε along the optical z-axis, wherein first freeform surface 1.1 can be described as the function:

z⁽¹⁾(x,y)=f(x,y)

and second freeform surface 2.1 as the function:

z⁽²⁾(x,y)=f(x,y)+ε.

FIG. 2 schematically shows the height profile:

Δz(x,y)=z⁽¹⁾(x,y)−f(0,0)=z⁽²⁾(x,y)−f(0,0)−ε

for freeform surfaces 1.1, 2.1 with respect to the center height at the respective reference point 1.1.1, 2.1.1, which is defined as a piercing point x=0, y=0 of the optical z-axis in freeform surface 1.1, 2.1. The height profile Δz(x,y) thus describes the change in the height of a freeform surface 1.1, 2.1 along the optical z-axis as a function of the Cartesian coordinates x,y, which are perpendicular to this optical z-axis, wherein this height change is given relative to the reference point x=0, y=0.

Optical elements 1, 2 have a circular cross section in the x,y plane. However, exemplary embodiments with a different cross-sectional geometry are also possible.

In a preferred embodiment of the invention, freeform surfaces 1.1, 2.1 are formed antisymmetric, wherein:

Δz(x,y)=Δz(−x,−y).

Then, optical elements 1, 2 have the same design, but are arranged rotated about the optical z-axis by 180° with the freeform surfaces 1.1, 2.1 facing each other and thus form a complementary pair of freeform surfaces 1.1, 2.1.

The height profile of freeform surfaces 1.1, 2.1 can be described by a polynomial expansion dependent on the lateral distances x,y relative to the optical z-axis for Cartesian coordinates of the form:

$$( x , y ) = {\sum }_{m = 1}^{M} {\sum }_{n = 1}^{N} {c}_{m , n} {x}^{m} {y}^{n} .$$

In addition, polynomial expansions for other coordinate systems, for example, polar coordinates, are possible. The conversion of a polynomial expansion for Cartesian coordinates into a polynomial expansion for another coordinate system is known from the prior art.

According to the invention, at least one of the polynomial orders M, N is selected as greater than 3.

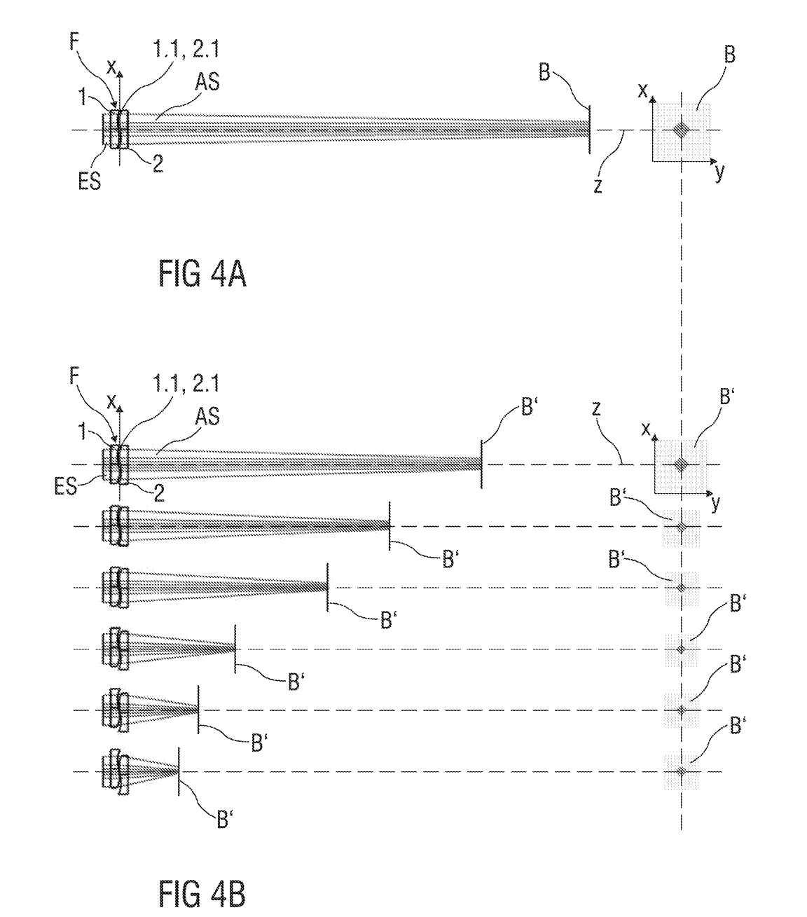

In the arrangement, shown in FIG. 1, in the zero position, therefore, at a horizontal offset Δx=0, the reference points 1.1.1, 2.1.1 lie congruently along the x-axis and the y-axis and are spaced from each other by the offset ε along the optical z-axis. In this zero position, input beams ES, collimated to the optical z-axis and distributed according to a Gaussian profile, are deflected in the beam direction when passing through beam shaper F such that the output beams AS, received on the exit side of beam shaper F in a receiving plane B, are distributed according to a rectangular beam density profile, as shown schematically in FIG. 4A. In the present case, the rectangular beam density profile is square without loss of generality.

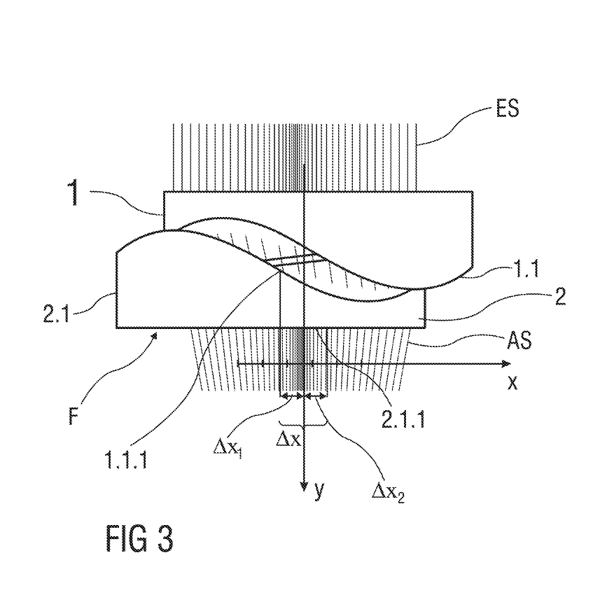

As shown schematically in FIG. 3, optical elements 1, 2 in beam shaper F of invention can be shifted against each other along the x-axis perpendicular to the optical z-axis and thus moved out of the zero position. A displacement of first optical element 1 by a first offset Δx₁ produces a first freeform surface 1.1 according to the function:

z⁽¹⁾(x,y)=f(x−Δx₁,y).

A displacement of second optical element 2 by a second offset Δx₂ produces a second freeform surface 2.1 according to the function:

z⁽²⁾(x,y)=f(x−Δx₂,y)+ε.

For the optical effect, only the relative displacement Δx=Δx₁−Δx₂ between freeform surfaces 1.1, 2.1 is essential in this case, because a similar displacement of both optical elements 1, 2 only causes an offset of the optical z-axis.

The relative displacement Δx, with an unchanged Gaussian input beam density distribution causes a change in the position and direction potentially of each output beam AS. In particular, the relative displacement Δx has the effect that a rectangular beam density distribution arises in a receiving plane B′, which is shifted opposite to the receiving plane B for the zero position Δx=0 along the optical z-axis. The relative displacement Δx can furthermore have the effect that in the shifted receiving plane B′ a rectangular beam density distribution forms with a dimension changed with respect to the zero position and thus also with a changed beam density.

The position of receiving plane B′, which position depends on the relative displacement Δx, and the dimension of the rectangular beam density distribution are schematically shown in FIG. 4B for different displacements Δx≠0.

The problem of determining a height profile Δz(x,y) for freeform surfaces 1.1, 2.1 in such a way that a desired optical effect is achieved as a function of a relative displacement Δx can be formulated such that for a plurality of beams S with entry points x_{S},y_{S} in an entrance plane corresponding receiving points x′_{S},y′_{S} can be established for the imaginary receiving plane B, B′ corresponding to the desired optical effect or beam shaping. Interpolation points for a height profile Δz(x,y) with which the desired paths of beams S are achieved can be determined from the set of entry points x_{S},y_{S} and assigned receiving points x′_{S},y′_{S} by beam calculation for a variety of relative displacements Δx.

Methods for the numerical determination of interpolation points for a height profile Δz(x,y) and, derived therefrom, for the numerical determination of the height profile Δz(x,y) itself are known in the art. In particular, methods are known with which coefficients c_{m,n} of a polynomial expansion [symbol] (x,y) for given polynomial orders M, N can be determined, which represents an approximation of the height profile Δz(x,y).

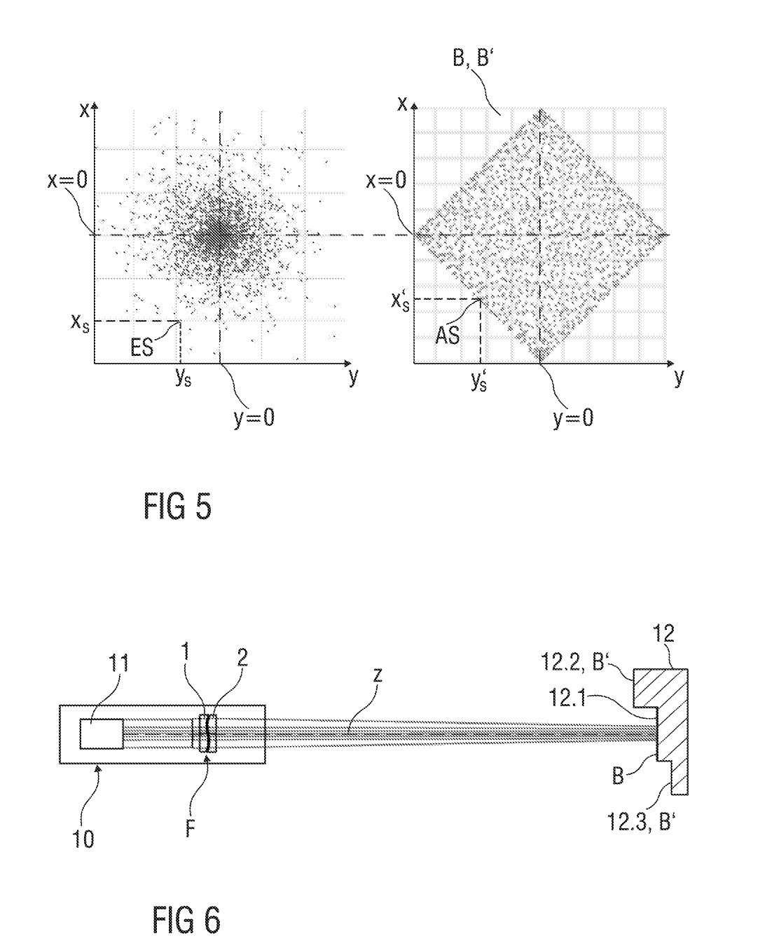

For example, for a relative displacement Δx=0, entry points x_{S},y_{S}, which are distributed according to a Gaussian rotationally symmetric beam density in an entrance plane, receiving points x′_{S},y′_{S} can be assigned to a receiving plane B, and are distributed substantially uniformly within a square cross section about the optical axis (z), as schematically shown in FIG. 5.

Analogously, for relative displacements Δx>0, entry points x_{S},y_{S}, distributed in a Gaussian manner in the entrance plane, and receiving points x′_{S},y′_{S}, also distributed uniformly but with reduced distances, are assigned to a receiving plane B′, wherein this receiving plane B′ with an increasing density of receiving points x′_{S},y′_{S} moves closer to beam shaper F. The optical effect of a relative displacement Δx to be taken from a zero position is schematically shown in FIG. 4B. This optical effect corresponds to a beam density also increasing with an increasing relative displacement Δx>0 and homogeneous within the rectangular cross section in the respective receiving plane B′, determined from the relative displacement Δx.

By means of a beam shaper F with such an optical effect, it is possible, for example, to transform the laser beam emerging from a laser source with a generally approximately rotationally symmetric beam density, distributed in a Gaussian manner, into a uniformly distributed beam density with a rectangular or square cross section about the optical axis (z). Such a uniform beam density distribution has many advantages over a Gaussian beam density distribution, in particular for material processing by means of laser, for example, a uniform, sharply delimited material removal.

FIG. 6 schematically shows a laser optic 10 with a laser source 11 and a beam shaper F. Laser source 11 is set up to emit laser light, which is collimated to an optical z-axis and has a Gaussian beam density profile, rotationally symmetric to the optical z-axis.

A beam shaper F of the invention with a first and second optical element 1, 2 is located downstream along the optical z-axis. Processing surfaces 12.1, 12.2, 12.3 of a workpiece 12 are arranged in the receiving planes B, B′ mutually dependent on the relative displacement Δx of optical elements 1, 2. In this case, a first processing surface 12.1 lies in the receiving plane B of the zero position, which results for optical elements 1, 2 that are not shifted (Δx=0). A second processing surface 12.2 lies in a receiving plane B′, which results for a positive relative displacement Δx>0. A third processing surface 12.3 lies in a receiving plane B′, which results for a negative relative displacement Δx<0.

Thus, by adjusting the relative displacement Δx an always uniform or homogeneous beam density distribution can be achieved for different working distances between laser optic 10 and a workpiece 11.

In addition or alternatively, it is also possible by adjusting the relative displacement Δx between the optical elements to change the extent of the rectangular cross-section of the uniform beam density distribution and at the same time bring into alignment a processing surface 12.1, 12.2, 12.3 of workpiece 12 with the corresponding receiving plane B, B′ by traversing along the optical z-axis. This makes it possible to change the beam density of a homogeneous beam density distribution with a rectangular cross section. It is thus possible, for example, to change a removal rate or removal depth in the case of ablating laser processing in a particularly simple manner.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A beam shaper comprising:
a first optical element; and
a second optical element arranged behind the first optical element along an optical axis,
wherein the first and second optical elements have at least one optically active freeform surface,
wherein the first and second optical elements are arranged displaceable against each other along at least one axis arranged substantially perpendicular to the optical axis by a relative displacement,
wherein the optically active freeform surfaces have a height profile that is a polynomial expansion having polynomial coefficients that are different from zero in finitely many polynomial orders,
wherein at least one polynomial coefficient assigned to a polynomial order greater than three is different from zero,
wherein the height profiles of the at least two freeform surfaces are selected such that input beams, distributed rotationally symmetric about the optical axis with a Gaussian beam density profile, are diffracted into output beams that are limited in a receiving plane within a rectangular cross section and are uniformly distributed about the optical axis, and
wherein a distance of the receiving plane and an extent of a limiting rectangular cross section is changeable relative to each other by the relative displacement of the at least two optical elements.

2. The beam shaper according to claim 1, wherein the limiting rectangular cross section is square.

3. The beam shaper according to claim 1, wherein the height profiles of the first and second freeform surfaces is formed antisymmetric with respect to a 180 degree rotation about the optical axis and arranged facing each other.

4. The beam shaper according to claim 1, wherein the optical elements are made of silica glass.

5. A laser optic comprising:
a laser source; and
a beam shaper according to claim 1, the beam shaper being arranged downstream of the laser source along an optical axis,
wherein the laser source is adapted to emit collimated laser light with a Gaussian beam density profile rotationally symmetric about the optical axis.
